(19) United States
(12) Patent Application Publication
(10) Pub. No.: US 2017/0106262 A1
(43) Pub. Date: Apr. 20, 2017

(54) GRIP FOR BALL-BAT HANDLE AND KNOB HAVING MULTIPLE DEGREES OF HARDNESS

(71) Applicant: EASTON BASEBALL / SOFTBALL INC., VAN NUYS, CA (US)

(72) Inventors: Keenan Long, Sherman Oaks, CA (US); Grant Douglas, Santa Monica, CA (US)

(21) Appl. No.: 14/918,513

(22) Filed: Oct. 20, 2015

(51) Int. Cl. A63B 60/14; B29C 70/76; A63B 60/08; A63B 59/50; A63B 60/16

(52) U.S. Cl. CPC A63B 60/14; A63B 59/50; A63B 60/16; A63B 60/08; B29C 70/76; A63B 2102/18

(57) ABSTRACT

A grip or cover for a sporting-good implement, such as a ball bat, includes a knob portion generally positioned around a knob of the bat, and a handle portion generally positioned around a handle region of the bat. The handle portion may be formed from a material that is harder than the knob portion. The knob or part of the handle region may include a grooved surface to engage with the grip to help retain the grip to the bat. In some embodiments, a method of manufacturing a bat or other sporting-good implement includes positioning a portion of a handle or knob in a mold and providing an elastomer in the mold to cover the portion of the handle and knob. In some embodiments, different portions of the elastomer may be cured at different temperatures to provide different material properties, such as different degrees of hardness, to those portions.

### BACKGROUND

Baseball and softball bats have conventionally included a knob at the end of the bat handle primarily to reduce the risk of the bat being thrown from a player's hands during a swing, particularly when the player loses grip on the handle. While conventional batting technique involves a player grasping the bat handle just above the knob, batters are increasingly adopting a different technique in which they grasp the knob with the palm of one hand and up to three fingers. This technique essentially provides a longer effective length of the bat, and, in turn, increased leverage for additional velocity and force against a batted ball. But grasping the knob while swinging a bat can increase the risk of wrist and palm injuries, and it also largely defeats the safety purpose of the knob because one hand is already partially off of the handle portion of the bat. Indeed, the knob-grasping technique puts added pressure on the hypothenar region of the palm, and, specifically, on the ulnar nerve, which can result in temporary failure of the ulnar nerve during the swing, resulting in injury or a thrown bat.

### SUMMARY

A handle-and-knob grip for a ball bat or other sporting-good implement includes multiple degrees of hardness. In some embodiments, a sporting-good implement includes a handle region, a knob, and a cover or grip, wherein the grip includes a knob portion generally positioned around the knob and an integral handle portion generally positioned around the handle region. The handle portion of the grip may be harder than the knob portion of the grip.

In some embodiments, a method of manufacturing a sporting-good implement includes providing a ball bat having a handle and a knob, providing a mold having a receiving space configured to accommodate a portion of the handle and the knob, and positioning the portion of the handle and the knob in the receiving space. An elastomer is provided in the receiving space to cover the knob, and, optionally, portions of the handle. Separate portions of the elastomer may be cured at different temperatures to yield different material properties, such as different hardness properties for the handle and knob portions of the resulting grip.

The grip allows a batter to hold the knob portion of a ball bat during a swing while reducing the risk of injury to the batter and the risk of a thrown bat. Other features and advantages will appear hereinafter. The features described above may be used separately or together, or in various combinations of one or more of them.

### BRIEF DESCRIPTION OF THE DRAWINGS

In the drawings, wherein the same reference number indicates the same element throughout the views:

FIG. 1 is a perspective view of a ball bat having a grip in accordance with an embodiment of the present technology.

FIG. 2 is a cross-sectional view of a mold for applying a grip in accordance with an embodiment of the present technology.

FIG. 3 is a perspective view of a ball bat machined or constructed to receive a grip in accordance with an embodiment of the present technology.

FIG. 4 is a cross-sectional view of the handle and knob portion of the ball bat shown in FIG. 3 positioned in a mold for applying a grip in accordance with an embodiment of the present technology.

### DETAILED DESCRIPTION

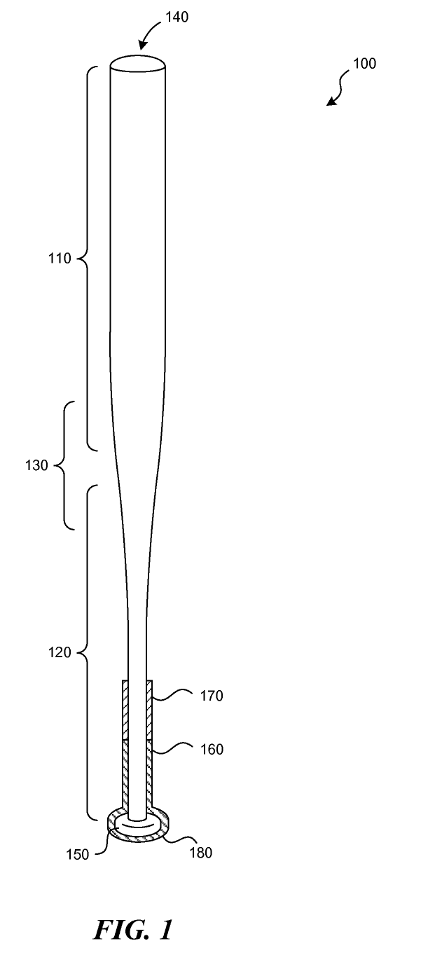

The present technology is directed to an integral handle and knob grip for a ball bat, the grip having multiple degrees of hardness, and associated systems and methods. Various embodiments of the technology will now be described. The following description provides specific details for a thorough understanding and enabling description of these embodiments. One skilled in the art will understand, however, that the invention may be practiced without many of these details. Additionally, some well-known structures or functions may not be shown or described in detail so as to avoid unnecessarily obscuring the relevant description of the various embodiments. Accordingly, the technology may have other embodiments with additional elements or without several of the elements described below with reference to FIGS. 1-4.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list. Further, unless otherwise specified, terms such as “attached” or “connected” are intended to include integral connections, as well as connections between physically separate components.

Specific details of several embodiments of the present technology are described herein with reference to baseball or softball. The technology may also be used in other sporting-good implements. The present technology allows a user to maximize velocity and force of a bat barrel during a swing while also reducing the risk of injury to the user and reducing the risk of a thrown bat. Examples of this technology are illustrated in FIGS. 1-4.

FIG. 1 illustrates a bat 100 having a barrel region 110 and a handle region 120. The bat 100 may be a baseball or softball bat, or it may be another suitable batting or hitting implement. The bat 100 is collectively referred to herein as a “ball bat” or “bat.” The ball bat 100 may include a transitional or taper region 130 in which the larger diameter of the barrel region 110 transitions to the narrower diameter of the handle region 120. The barrel region 110 may be closed with an end cap 140. In some embodiments, an end cap may be excluded, for example, in bats generally formed from solid wood or other solid materials.

An integral or attached knob 150 is positioned at a distal end of the handle region 120. The knob 150 may have a generally circular configuration extending circumferentially about the end of the handle region 120, or it may have another suitable configuration.

The ball bat 100 may have any suitable dimensions. The ball bat 100 may have an overall length of 20 to 40 inches, or 26 to 34 inches. The overall barrel diameter may be 2.0 to 3.0 inches, or 2.25 to 2.75 inches. Typical ball bats have diameters of 2.25, 2.625, or 2.75 inches. Bats having various combinations of these overall lengths and barrel diameters, or any other suitable dimensions, are contemplated herein. The specific preferred combination of bat dimensions is generally dictated by the user of the bat 100, and may vary greatly between users.

At least a portion of the handle region 120 and the knob 150 are covered with an integral, single-piece grip 160. In some embodiments, the grip 160 covers the entire knob 150. The grip 160 may extend from the knob 150 up to a distance of approximately 10 inches along the handle region 120. Accordingly, in some embodiments, the grip 160 may accommodate both of a player's hands. In other embodiments, the grip 160 may extend a shorter distance from the knob 150 (for example, approximately 0.5 inches) along the handle region 120. Accordingly, in some embodiments, the grip 160 may accommodate only the portion of the player's hand that grasps the knob 150. In yet other embodiments, the grip 160 may extend from the knob 150 to other distances along the handle region 120, such as a distance in the range of 0.5 inches to 10 inches, or other suitable distances, depending on user preference. In some embodiments, one or more additional grips may be included on the handle region 120 to accommodate a player's upper hand (and potentially a portion of the player's lower hand, depending on the size of the grip 160).

The grip 160 may be formed with a different degree of hardness (i.e., durometer measurement) in a handle portion 170 of the grip 160 than in a knob portion 180 of the grip 160. For example, the knob portion 180 of the grip 160 may exhibit a softer degree of hardness in order to allow the knob portion 180 to temporarily deform slightly during the period of the swing that is most often associated with injury. Such deformation may temporarily result in increased contact surface area of the grip 160, which results in less pressure on the hypothenar region of the hand, and therefore less risk of injury or risk of a thrown bat. Accordingly, a user can use a technique that involves gripping the knob 150 for higher barrel velocity during a swing, while the grip 160 reduces the risk of injury or a thrown bat.

The handle portion 170 of the grip 160 may be configured to have a higher degree of hardness than that of the knob portion 180 so that the upper hand (closest to the barrel region 110) can grip the bat 100 without causing much deformation of the handle portion 170. This higher degree of hardness in the handle portion 170 may be desirable to players wanting their top hand to feel more connected to the bat 100 so that they receive the sensory input necessary to make fine adjustments to better position the barrel region 110 to impact a ball during a swing.

Accordingly, a bat 100 using a grip 160 of the present technology can provide enhanced safety for the user, and for other players and spectators, when the user employs a gripping technique that involves grasping the knob 150, while also maintaining proper feel for the upper hand on the handle portion 170 for control of the swing. A grip 160 of the present technology may also be advantageous for a player using a standard or traditional batting grip (in which both hands are positioned on the handle region 120 above the knob 150) because, in such a traditional grip, the bottom hand (closest to the knob 150) still receives the most force, particularly when the user decelerates the bat.

In some embodiments, the grip 160 may be formed from silicone, urethane, rubber, or polyurethane foam. In other embodiments, the grip 160 may be formed from other suitable materials, including other elastomers. The grip may be formed from multiple, different materials, for example, one material may form the handle portion 170 while another material may form the knob portion 180. In other embodiments, the grip material may be generally uniform throughout the grip 160. In such embodiments, the grip material may be provided with different degrees of hardness in various locations by curing the material in various locations at different temperatures. For example, the handle portion 170 may be cured at a different temperature than the knob portion 180 to provide the handle portion 170 with a higher degree of hardness (or a lower degree of hardness, if desired).

In some embodiments, portions of the grip 160 may have degrees of hardness ranging from approximately Shore 20A to Shore 60D. The hardness of the handle portion 170 and the knob portion 180 may vary according to user preference. For example, in some embodiments, the handle portion 170 may have a degree of hardness between approximately Shore 60A and Shore 60D. And in some embodiments, the knob portion 180 may have a degree of hardness between approximately Shore 40A and Shore 70A. In other embodiments, other suitable degrees of hardness may be used.

The handle portion 170 of the grip 160 may have a thickness within the range of approximately 0.03 inches to 0.25 inches. For example, in some embodiments, the handle portion 170 may have a thickness of 0.05 inches. The knob portion 180 of the grip 160 may have a thickness within the range of approximately 0.125 inches to 0.400 inches. For example, in some embodiments, the knob portion 180 may have a thickness of approximately 0.4 inches. In other embodiments, other suitable dimensions may be used.

During testing, the inventors were surprised to observe that batters using embodiments of the present technology achieved increased exit velocities relative to similar ball bats that did not include a knob-and-handle grip 160. These increased exit velocities generally occurred even after the batter took over 100 swings, which is surprising because exit velocities typically decrease as a batter's hands become fatigued and damaged from such a high number of swings. And a batter will generally produce approximately the same exit velocity when swinging bats having a given barrel, but the inventors were surprised to observe that batters experienced increased exit velocities when using bats having the same barrel but incorporating grips 160 of the present technology.

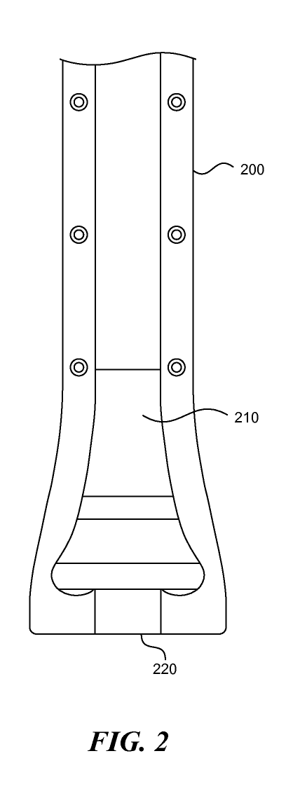

FIG. 2 is a cross-sectional view of an exemplary mold 200 for applying a grip (e.g., 160) to a bat (e.g., 100) in accordance with an embodiment of the present technology. As illustrated in FIG. 2, the mold 200 may have a receiving space or void 210 generally shaped to receive a knob (e.g., 150) and at least a portion of the handle region (e.g., 120) of a bat 100. The void may be appropriately sized to be larger than the bat in order to accommodate material to form the grip 160, which may enter through an opening 220 at an end of the mold 200 near the knob of the bat. In other embodiments, the opening 220 (or openings) may be located at other parts of the mold 200. Material for forming the grip (e.g., 160) may be poured, injected, or otherwise placed into the mold 200 around the knob and handle regions of the bat and then allowed to cure. Accordingly, the grip 160 may be permanently bonded to the bat 100.

In order to provide different degrees of hardness for the grip 160, as described above, different materials may be poured, injected, or otherwise placed into the mold 200 in sequence. In other embodiments, as described above, different levels of heat may be applied to the handle portion (e.g., 170) of the grip 160 than to the knob portion (e.g., 180) of the grip 160 to provide different material properties, such as the degrees of hardness. Other suitable curing processes may be used to yield different material properties. In yet other embodiments, adjusting the thickness of various portions of the grip (e.g., the handle portion 170 and the knob portion 180) may facilitate adjustment of hardness.

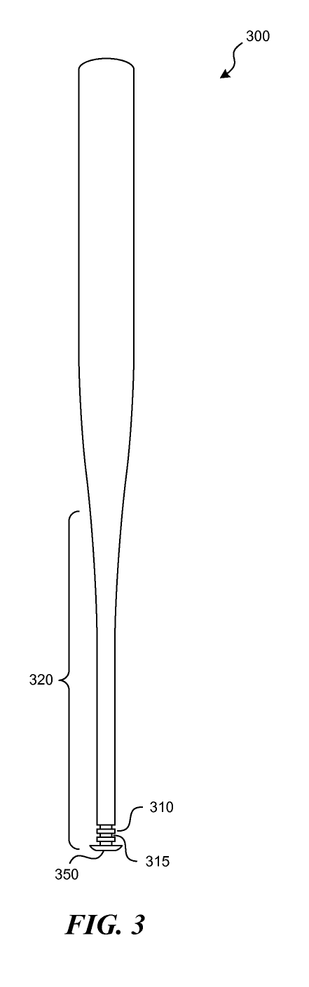

FIG. 3 generally illustrates a ball bat 300 machined or constructed to receive a grip (e.g., 160) in accordance with an embodiment of the present technology. In some embodiments, the bat 300 may be generally similar to the bat 100 illustrated in FIG. 1, and it may further include a grooved surface 310 located at a portion of the handle region 320 near the knob 350. In some embodiments, the grooved surface 310 may include part of the knob 350. In other embodiments, the grooved surface 310 may be positioned only on the knob 350, or it may be positioned only on the portion of the handle region 320 just above the knob 350. The grooved surface 310 may be formed by machining or forming the ball bat 100 to include one or more grooves 315 that engage the grip (e.g., 160) to form a locked interface, which helps prevent the grip from disengaging from the bat 300. For example, during the molding process, the grip material may flow into the grooves 315.

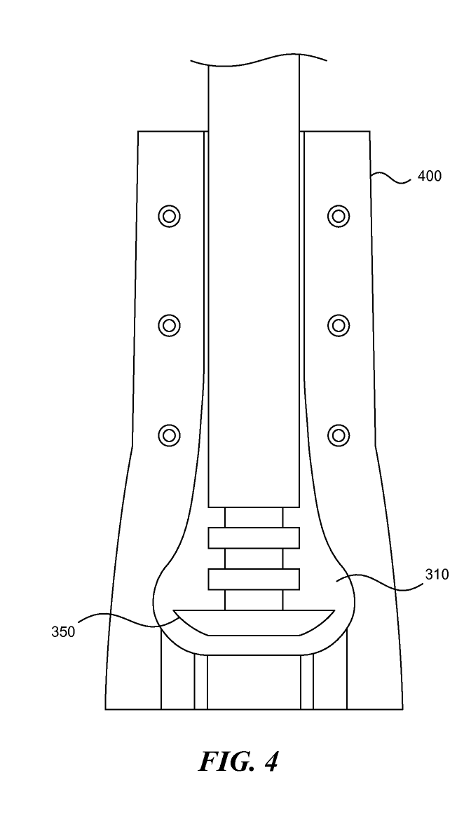

FIG. 4 illustrates a cross-sectional view of a portion of the ball bat 300 shown in FIG. 3, positioned in a mold 400 for receiving a grip (e.g., 160) in accordance with an embodiment of the present technology. Material for forming the grip may be poured, injected, or otherwise placed into the mold 400 from the end of the mold 400 closest to the knob 350, or from one or more other suitable areas. The grip material may flow into the grooves 315 before curing. After curing, the bat 300, including the grip (e.g., 160) that engages the grooves 315, may be removed from the mold 400.

From the foregoing, it will be appreciated that specific embodiments of the disclosed technology have been described for purposes of illustration, but that various modifications may be made without deviating from the technology, and elements of certain embodiments may be interchanged with those of other embodiments. For example, in some embodiments, the ball bats (e.g., 100, 300) may be made from wood, metal, composites, or other suitable materials. In further embodiments, the grooves (e.g., 315) may be formed by adding protrusions to the bat rather than removing material from the bat. In yet further embodiments, the grip may include holes, perforations, aesthetic coloring, or other suitable variations.

Further, while advantages associated with certain embodiments of the disclosed technology have been described in the context of those embodiments, other embodiments may also exhibit such advantages, and not all embodiments need necessarily exhibit such advantages to fall within the scope of the technology. Accordingly, the disclosure and associated technology may encompass other embodiments not expressly shown or described herein, and the invention is not limited except as by the appended claims.

What is claimed is:

1. A sporting-good implement, comprising:
a body including a handle region;
a knob at a distal end of the handle region; and
a grip including:
a knob portion positioned over the knob; and
a handle portion positioned over at least a portion of the handle region;
wherein at least a portion of the handle portion has a higher hardness than at least a portion of the knob portion.

2. The sporting-good implement of claim 1 wherein the knob portion and the handle portion are formed from the same material.

3. The sporting-good implement of claim 1 wherein the knob portion extends partially along the handle region.

4. The sporting-good implement of claim 1 further comprising a grooved surface area positioned to engage an interior region of the grip.

5. The sporting-good implement of claim 4, wherein the grooved surface area comprises one or more grooves in the knob.

6. The sporting-good implement of claim 1 wherein the grip is formed from materials comprising one or more of silicone, urethane, rubber, and polyurethane foam.

7. The sporting-good implement of claim 1 wherein the sporting-good implement is a ball bat including a barrel region attached to or integral with the handle region.

8. A grip for a sporting-good implement, comprising:
a knob portion configured to be positioned around a knob; and
a handle portion adjacent to the knob portion;
wherein the knob portion is formed from a first material having a first degree of hardness, and the handle portion is formed from a second material having a second degree of hardness that is different from the first degree of hardness.

9. The grip of claim 8 wherein the first degree of hardness is less than the second degree of hardness.

10. The grip of claim 8 wherein the second material comprises the same material as the first material cured to a different hardness.

11. The grip of claim 8 wherein one of the first and second materials comprises one or more of silicone, urethane, rubber, and polyurethane foam.

12. The grip of claim 8 wherein the knob portion is integral with the handle portion.

13. The grip of claim 8 wherein the grip is configured to fit over a knob and handle region of a ball bat.

14. A method of manufacturing a sporting-good implement, the method comprising:
providing a ball bat including a handle and a knob;
providing a mold including a receiving space configured to accommodate at least a portion of the handle and the knob;
positioning at least the portion of the handle and the knob in the receiving space; and
providing an elastomer into the receiving space to cover the knob and at least the portion of the handle; and
curing the elastomer to form a grip over the knob and at least the portion of the handle.

15. The method of claim 14, wherein curing the elastomer comprises curing a first portion of the elastomer using a first temperature, and curing a second portion of the elastomer using a second temperature.

16. The method of claim 15 wherein the first portion of the elastomer is positioned over the knob and is cured to a first degree of hardness that is less than a second degree of hardness to which the second portion of the elastomer is cured.

17. The method of claim 14 wherein curing the elastomer comprises curing a first portion of the elastomer to a first degree of hardness, and curing a second portion of the elastomer to a second degree of hardness different from the first degree of hardness.

18. The method of claim 17 wherein the second degree of hardness is greater than the first degree of hardness.

19. The method of claim 14 wherein the handle includes a grooved area into which the elastomer may flow before curing.

20. The method of claim 14 wherein the knob includes a grooved area into which the elastomer may flow before curing.
